(19) United States
(12) Patent Application Publication
(10) Pub. No.: US 2025/0145748 A1
(43) Pub. Date: May 8, 2025

(54) CARBOXYLIC ACID COSOLVENTS IN THE PRODUCTION OF ETHYLENE ACID COPOLYMER

(71) Applicant: Dow Global Technologies LLC, Midland, MI (US)

(72) Inventors: Ivan A. Konstantinov, Lake Jackson, TX (US); Christopher R. Eddy, Lake Jackson, TX (US); Sean W. Ewart, Lake Jackson, TX (US); Bruce M. Hasch, Lake Jackson, TX (US); David Koenigs, Lake Jackson, TX (US); Shannon Meerscheidt, Lake Jackson, TX (US); Sarat Munjal, Frisco, TX (US)

(73) Assignee: Dow Global Technologies LLC, Midland, MI (US)

(21) Appl. No.: 18/832,289

(22) PCT Filed: Jan. 27, 2023
(86) PCT No.: PCT/US2023/061439

§ 371 Date: Jul. 23, 2024

Related U.S. Application Data
(60) Provisional application No. 63/304,890, filed on Jan. 31, 2022.

(51) Int. Cl. C08F 220/06; C08F 2/06

(52) U.S. Cl. CPC C08F 220/06; C08F 2/06; C08F 2400/04

(57) ABSTRACT

Embodiments of the present disclosure are directed to methods for producing ethylene acid copolymer comprising: polymerizing via free-radical polymerization at a pressure of at least 1000 atmospheres (atm) an ethylene monomer and unsaturated carboxylic acid containing comonomer to produce the ethylene acid copolymer, wherein the ethylene monomer and unsaturated carboxylic acid containing comonomer are in a mixture comprising at least one saturated carboxylic acid cosolvent, and wherein the at least one saturated carboxylic acid cosolvent having a boiling point less than 237° C. at 1 atm pressure and is present in the mixture at an amount of 1 to 25 wt. %.

### CROSS-REFERENCE TO RELATED APPLICATION

This application claims the benefit of and priority to U.S. Application Ser. No. 63/304,890 filed on Jan. 31, 2022, and entitled “CARBOXYLIC ACID COSOLVENTS IN THE PRODUCTION OF ETHYLENE ACID COPOYMER,” the entire contents of which are incorporated by reference in the present disclosure.

### TECHNICAL FIELD

Embodiments described herein generally relate to ethylene acid copolymer and specifically relate to the use of saturated carboxylic acid cosolvents to reduce phase separation.

### BACKGROUND

With ethylene acid copolymers, phase separation within the free radical solution mixture is problematic because it can limit acid incorporation in the polymer. Moreover, as the amount of acid in the polymer chains increases, phase separation may cause fouling and gel issues. Thus, methanol cosolvents are conventionally used to reduce phase separation. However, high amounts of methanol may increase corrosion. Furthermore, methanol may act as a chain transfer agent to reduce molecular weight capability of the process.

Consequently, there is a need to replace methanol as a cosolvent.

### SUMMARY

Embodiments of the present disclosure meet this need by replacing methanol with a saturated carboxylic acid cosolvent that can reduce phase separation as well as reduce polymer chain termination and corrosion.

According to at least one embodiment of the present disclosure, A method for producing ethylene acid copolymer comprising: polymerizing via free-radical polymerization at a pressure of at least 1000 atmospheres (atm) an ethylene monomer and unsaturated carboxylic acid containing comonomer to produce the ethylene acid copolymer, wherein the ethylene monomer and unsaturated carboxylic acid containing comonomer are in a mixture comprising at least one saturated carboxylic acid cosolvent, and wherein the at least one saturated carboxylic acid cosolvent having a boiling point less than 237° C. at 1 atm pressure and is present in the mixture at an amount of 1 to 25 wt. %.

These and other embodiments are described in more detail in the following drawings and Detailed Description.

### BRIEF DESCRIPTION OF THE DRAWINGS

FIG. 1 is a graph of the cloud point data for Example 1;

FIG. 2 is a graph of the cloud point data for Example 2;

FIG. 3 is a graph of the cloud point data for Example 3; and

FIG. 4 is a graph of the cloud point data for Example 4.

### DETAILED DESCRIPTION

Specific embodiments of the present application will now be described. These embodiments are provided so that this disclosure will be thorough and complete and will fully convey the scope of the subject matter to those skilled in the art.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

“Ethylene acid copolymer” is a polymerized reaction product of ethylene and one or more unsaturated carboxylic acid containing monomers.

Embodiments are directed to a method for producing ethylene acid copolymer comprising the steps of polymerizing via free-radical polymerization at a pressure of at least 1000 atmospheres (atm) an ethylene monomer and unsaturated carboxylic acid containing comonomer to produce the ethylene acid copolymer. The ethylene monomer and unsaturated carboxylic acid containing comonomer are in a mixture comprising at least one saturated carboxylic acid cosolvent. The saturated carboxylic acid cosolvent had a boiling point less than 237° C. at 1 atm pressure and is present in the mixture at an amount of 1 to 25 wt. %.

### Ethylene Acid Copolymer

In embodiments, the unsaturated carboxylic acid containing comonomer may include unsaturated monocarboxylic acids such as acrylic acid, methacrylic acid, or combinations thereof. In embodiments, the unsaturated carboxylic acid containing comonomer may be present in an amount of from 5 wt. % to 35 wt. %, from 12 to 30 wt. %, from 15 wt. % to 25 wt. %, or from 21 wt. % to 25 wt. % based on a total weight of the monomers present in the ethylene acid copolymer. Conversely, the ethylene content of the ethylene acid copolymer is greater than 50 wt. %, or greater than 60 wt. %. For example, the ethylene content of the ethylene acid copolymer is from 50 wt. % to 95 wt. %, from 70 wt. % to 88 wt. %, from 75 wt. % to 85 wt. %, or from 75 wt. % to 79 wt. %. In embodiments, the ethylene acid copolymer may have a melt index (I₂) of from 1 to 2000 dg/10 min, from 10-100 dg/10 min, from 20-80 dg/10 min, or from 1500 to 2000 dg/min as measured according to ASTM D-1238 (190° C./2.16 Kg).

### Solvents

The mixture may further include at least one solvent. In one embodiment, the solvent includes supercritical ethylene. The solvent may also include hydrocarbon solvents, which may include, but are not limited to, mineral solvents, e.g. from mineral oils, normal paraffinic solvents, isoparaffinic solvents, cyclic solvents, and the like. The hydrocarbon solvents may, for example, be selected from the group consisting of n-octane, iso-octane (2,2,4-trimethylpentane), n-dodecane, iso-dodecane (2,2,4,6,6-pentamethylheptane), and other isoparaffinic solvents. The solvent may be present in the mixture at less than 99 wt. %, from 5 to 95 wt. %, from 5 to 90 wt. %, or from 10 to 90 wt. %.

### Cosolvents

As stated above, the cosolvents include one or more saturated carboxylic acids having a boiling point less than 237° C. at 1 atm pressure. Without being bound by theory, saturated carboxylic acids having these lower boiling points reduce the likelihood of phase separation while also reducing corrosion and chain termination. Suitable cosolvents may include formic acid, acetic acid, propanoic acid, 2-methylpropanoic acid, butyric acid, pentanoic acid, 2-methylbutanoic acid, 3-methylbutanoic acid, pivalic acid (2,2-dimethylpropanoic acid), hexanoic acid, 2,3-dimethylbutanoic acid, 3,3-dimethylbutanoic acid, 2,3-dimethylpentanoic acid, heptanoic acid, cyclohexanecarboxylic acid, and combinations thereof. In one embodiment, the saturated carboxylic acid cosolvent comprises pivalic acid, acetic acid, or combinations thereof. The cosolvent may be present in the mixture at amounts ranging from of 1 to 25 wt. %, from 1 to 20 wt. %, from 3 to 20 wt. %, or from 5 to 15 wt. %.

The free radical polymerization process is generally known in the art. Generally the process is conducted at elevated temperatures and pressures in either a batch-wise process or continuous manner. Suitable reactors such as tubular reactors or autoclave reactors are familiar to the person of skill in the art. Additionally, compressor units upstream of the reactors and separator units downstream of the reactors are also familiar to the skilled person. The polymerization pressure may be in the range of at least 1000 atm (101.3 MPa or 1013.25 bar), from 1000 to 5000 atm, from 1200 to 4000 atm, or from 1500 to 3500 atm. The polymerization temperature is typically in the range of about 70° C. to about 380° C. All individual values and subranges in the range of about 70° C. to about 380° C. are included herein and disclosed herein; for example, polymerization temperature is in the range of 100° C. to 300° C., or from 150° C. to 250° C.

In addition to the above described components, additional additives such as initiators, inhibitors, chain transfer agents, and the like are also contemplated as being part of the mixture fed to the reactor.

### Test Methods

Melt Index (190° C., 2.16 kg, “I₂”) Test Method: ASTM D 1238-13, Standard Test Method for Melt Flow Rates of Thermoplastics by Extrusion Plastometer, using conditions of 190° C./2.16 kilograms (kg). Results were reported in units of grams eluted per 10 minutes (g/10 min.) or the equivalent in decigrams per 1.0 minute (dg/1 min.).

### Examples

The following examples illustrate features of the present disclosure but are not intended to limit the scope of the disclosure.

### Cloud Point Experiments

An optical cell was used to measure the cloud point curves for each cosolvent in accordance with the experimental method published in Macromol. Chem. Phys., 2003, 204, 638-645. Cloud point is the temperature and pressure below which a solution phase-separates. The experimental solutions included 10 wt. % ethylene acid copolymer, supercritical ethylene solvent, cosolvents listed in Table 1 at various weight percentages, and 0.5 wt. % BHT (butylated hydroxytoluene) inhibitor. The solutions were placed in the optical cell and heated to the desired temperature, which as shown was in the range of 178 to 240° C. The cell was then pressurized above the cloud point to ensure it was in the single phase (homogeneous) regime. Pressure was then lowered until the cloud point was found. The optical cell was then heated to the next temperature point.

The ethylene acid copolymers utilized in the Examples were prepared by standard free-radical copolymerization methods, using high pressure, operating in a continuous manner. Monomers are fed into the reaction mixture in a proportion, which relates to the monomer's reactivity, and the amount desired to be incorporated. In this way, uniform, near-random distribution of monomer units along the chain is achieved. Polymerization in this manner is well known, and is described in U.S. Pat. No. 4,351,931 (Armitage), which is hereby incorporated by reference. Other polymerization techniques are described in U.S. Pat. No. 5,028,674 (Hatch et al.) and U.S. Pat. No. 5,057,593 (Statz), both of which are also hereby incorporated by reference.

TABLE 1
Cosolvents

| Cosolvent | Boiling Point (° C.) at 1 atm | |
|---|---|---|
| Methanol | 64.7° | C. |
| Formic Acid | 100.8° | C. |
| Acetic Acid | 118° | C. |
| Pivalic Acid | 163.8° | C. |

### Example 1

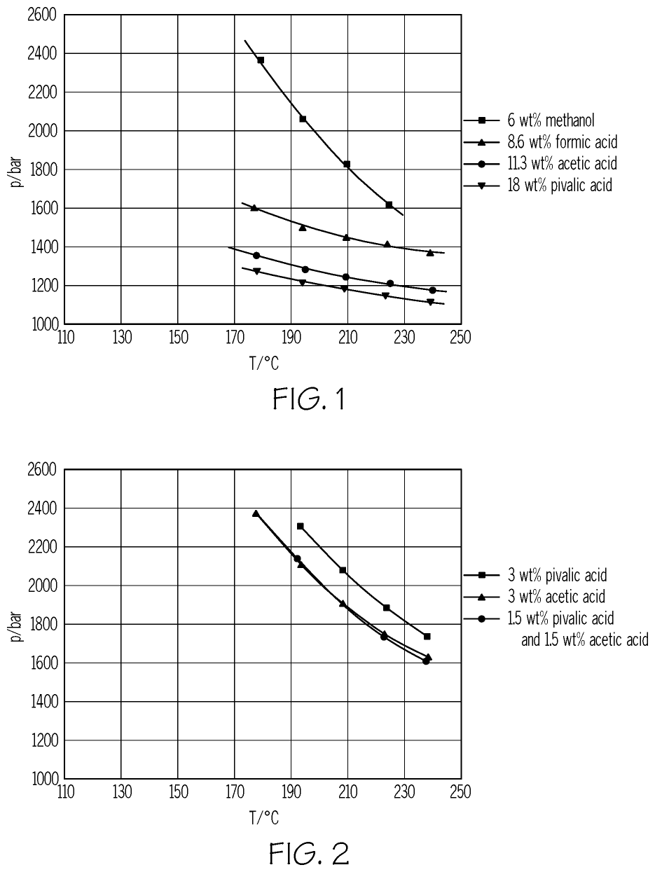

For Example 1 as shown in Table 2 and FIG. 1, the ethylene acid copolymer comprised 19 wt. % methacrylic acid comonomer and a melt index (I₂) of 60 g/10 mins. Various cosolvent amounts were utilized with the amount of cosolvent chosen to be equimolar to 6 wt. % methanol. As shown, the cloud point pressure values at each temperature point were significantly lower than the methanol, especially as the amount of saturated carboxylic acid was increased. As stated above, this is advantageous as there will not be phase separation at lower temperatures and pressures as in the case of methanol.

TABLE 2

| Cosolvent | T(° C.)/P(bar) | T(° C.)/P(bar) | T(° C.)/P(bar) | T(° C.)/P(bar) | T(° C.)/P(bar) |
|---|---|---|---|---|---|
| 6 wt. % | 178.8/2360 | 193.9/2060 | 209.2/1830 | 224.5/1620 | |
| Methanol | | | | | |
| 8.6 wt. % | 177.4/1605 | 194/1505 | 209.6/1453 | 224/1413 | 238.9/1374 |
| Formic Acid | | | | | |
| 11.3 wt. % | 177.8/1360 | 194.4/1288 | 209.8/1246 | 224.8/1210 | 239.9/1175 |
| Acetic Acid | | | | | |
| 18 wt. % | 177.8/1276 | 193.7/1222 | 208.7/1184 | 223.5/1150 | 239/1114 |
| Pivalic Acid | | | | | |

### Example 2

For Example 2 as shown in Table 3 and FIG. 2, the same ethylene acid copolymer as Example 1 was used with various cosolvents added at 3 wt. %. As shown in comparison to Example 1, even lower amounts of cosolvent reduced the cloud point of the solution.

TABLE 3

| Cosolvent | T(° C.)/P(bar) | T(° C.)/P(bar) | T(° C.)/P(bar) | T(° C.)/P(bar) | T(° C.)/P(bar) |
|---|---|---|---|---|---|
| 3 wt. % | | 193.3/2300 | 208.1/2074 | 223.4/1878 | 238.1/1730 |
| Pivalic Acid | | | | | |
| 3 wt. % | 177.9/2370 | 193.9/2096 | 208.3/1900 | 223.1/1749 | 238.6/1622 |
| Acetic Acid | | | | | |
| 1.5 wt. % | | 192.5/2135 | 207.7/1897 | 222.6/1734 | 237.9/1603 |
| Pivalic Acid | | | | | |
| and 1.5 wt. % | | | | | |
| acetic Acid | | | | | |

### Example 3

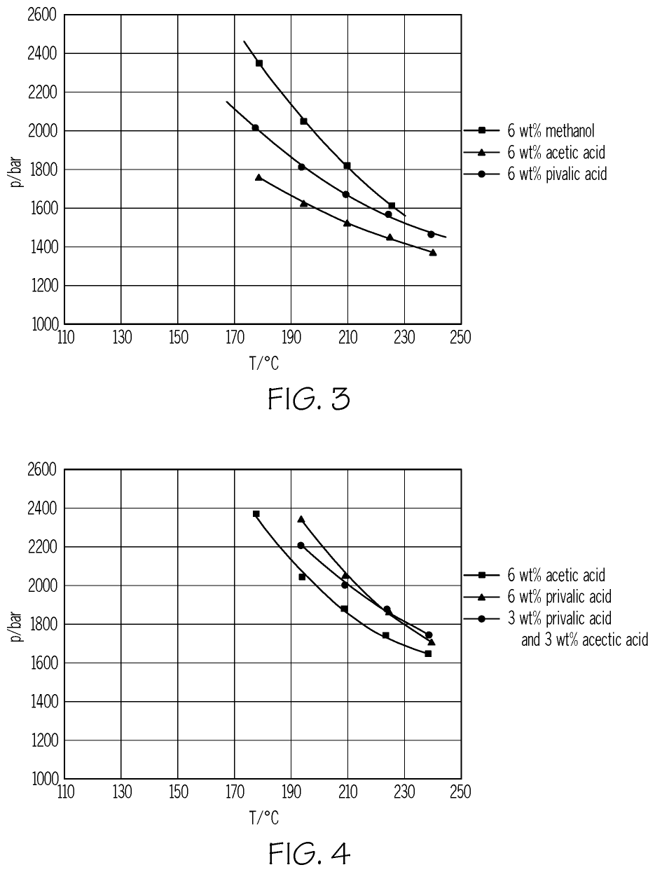

For Example 3 as shown in Table 4 and FIG. 3, the same ethylene acid copolymer as Examples 1 and 2 was used with various cosolvents added at 6 wt. %. As shown in comparison to Example 1, even lower amounts of cosolvent reduced the cloud point of the solution. Moreover, at a temperature of approximately 194° C., the cloud point is significantly less for the pivalic acid at the same concentration as the methanol.

TABLE 4

| Cosolvent | T(° C.)/P(bar) | T(° C.)/P(bar) | T(° C.)/P(bar) | T(° C.)/P(bar) | T(° C.)/P(bar) |
|---|---|---|---|---|---|
| 6 wt. % | 178.8/2360 | 193.9/2060 | 209.2/1830 | 224.5/1620 | |
| Methanol | | | | | |
| 6 wt. % | 178.6/1771 | 194/1630 | 209.1/1530 | 224.1/1460 | 238.9/1381 |
| Acetic Acid | | | | | |
| 6 wt. % | 177.7/2023 | 193.4/1820 | 208.7/1678 | 223.4/1572 | 238.5/1473 |
| Pivalic Acid | | | | | |

### Example 4

For Example 4 as shown in Table 5 and FIG. 4, an ethylene acid copolymer with 22 wt. % methacrylic acid comonomer and a melt index (I₂) of 25 dg/min used with various cosolvents added at 6 wt. %. As shown, even with larger methacrylic acid incorporation, there is still a reduced cloud point of the solution due to the saturated carboxylic acid cosolvent.

TABLE 5

| Cosolvent | T(° C.)/P(bar) | T(° C.)/P(bar) | T(° C.)/P(bar) | T(° C.)/P(bar) | T(° C.)/P(bar) |
|---|---|---|---|---|---|
| 6 wt. % | 177.4/2360 | 193.2/2029 | 208.4/1877 | 222.6/1740 | 237.8/1633 |
| Acetic Acid | | | | | |
| 6 wt. % | | 193.2/2333 | 208.8/2040 | 223.7/1860 | 238.9/1700 |
| Pivalic Acid | | | | | |
| 3 wt. % | | 193.2/2200 | 208.6/1995 | 223.3/1865 | 238/1735 |
| Pivalic Acid + | | | | | |
| 3 wt. % | | | | | |
| Acetic Acid | | | | | |

### Corrosion Data

For the corrosion study, a 40 mL glass vial was charged with tetradecane, a carbon steel coupon, methacrylic acid, and pivalic acid. Total mass inside the vial excluding the mass of the carbon steel coupon equaled 10 g. The vial was heated to 100° C. for 7 days. After that, the vial was allowed to cool to ambient temperature and the carbon steel coupon was removed. The amount of corrosion was determined by mass balance/weight loss of the carbon steel coupon and is provided in Table 6.

TABLE 6

| | | | | | Weight Loss |
|---|---|---|---|---|---|
| | | | Meth- | | of Carbon |
| | Tetradecane | Methacrylic | anol | Pivalic | Steel Coupon |
| Coupon | (g) | Acid (g) | (g) | Acid (g) | (mg) |
| 1 | 8 | 2 | — | — | 13.0 |
| 2 | 7.5 | 2 | 0.5 | — | 80.3 |
| 3 | 7 | 2 | 1 | — | 94.9 |
| 4 | 7.5 | 2 | — | 0.5 | 26.3 |
| 5 | 7 | 2 | — | 1 | 31.7 |
| 6 | 9 | — | 1 | — | <1.0 |
| 7 | 9 | — | — | 1 | <2.0 |

The results indicated that methanol or pivalic acid alone do not show significant corrosion of the carbon steel coupon (<2.0 mg loss of mass). The baseline of only methacrylic acid showed loss of mass equal to 13.0 mg. This can be considered a normal background corrosion coming from the fact that methacrylic acid is always present in the process. The combination of methacrylic acid and methanol results in a significantly increased corrosion. The two experiments of 2 g methacrylic acid and 0.5 g methanol and 2.0 g methacrylic acid and 1.0 g methanol produced 80 mg and 95 mg of coupon mass loss, respectively. While methanol itself is not corrosive at all, only the combination with methacrylic acid (as is currently practiced in the process) drastically increased corrosion on carbon steel. Pivalic acid resulted in less corrosion in combination with methacrylic acid compared to methanol with two experiments producing coupon mass loss of 26 mg and 32 mg, respectively. Thus, the data demonstrated that improved corrosion is achieved by replacing methanol with pivalic acid as the cosolvent in addition to the other benefits pivalic acid delivers.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A method for producing ethylene acid copolymer comprising:
polymerizing via free-radical polymerization at a pressure of at least 1000 atmospheres (atm) an ethylene monomer and unsaturated carboxylic acid containing comonomer to produce the ethylene acid copolymer, wherein the ethylene monomer and unsaturated carboxylic acid containing comonomer are in a mixture comprising at least one saturated carboxylic acid cosolvent, and wherein the at least one saturated carboxylic acid cosolvent having a boiling point less than 237° C. at 1 atm pressure and is present in the mixture at an amount of 1 to 25 wt. %.

2. The method of claim 1, wherein the ethylene acid copolymer comprises from 5 to 35 wt. %, or from 12 to 30 wt. % unsaturated carboxylic acid containing comonomer incorporated therein.

3. The method claim 1, wherein the ethylene acid copolymer comprises a melt index (h) from 1 to 2000 dg/min as measured according to ASTM D-1238 (190° C./2.16 Kg).

4. The method of claim 1, wherein the unsaturated carboxylic acid containing comonomer comprises acrylic acid, methacrylic acid, or combinations thereof.

5. The method of claim 1, wherein at least one saturated carboxylic acid cosolvent comprises pivalic acid, acetic acid, formic acid, or combinations thereof.

6. An ethylene acid copolymer comprising the polymerized reaction product of ethylene monomer and carboxylic acid comonomer, wherein the ethylene acid copolymer comprises greater than 20 wt. % acid comonomer and a melt index (I₂) from 1 to 2000 dg/min as measured according to ASTM D-1238 (190° C./2.16 Kg).
